(19) United States
(12) Patent Application Publication
(10) Pub. No.: US 2010/0318651 A1
(43) Pub. Date: Dec. 16, 2010

(54) Network Communication System With Monitoring

(75) Inventors: Joseph McCoy, Frankfort, NY (US); Joshua White, Ilion, NY (US)

Correspondence Address: BOND, SCHOENECK & KING, PLLC, ONE LINCOLN CENTER, SYRACUSE, NY, 13202-1355, US

(73) Assignee: EVERIS, INC., Frankfort, NY (US)

(21) Appl. No.: 12/813,193

(22) Filed: Jun. 10, 2010

Related U.S. Application Data
(60) Provisional application No. 61/185,703, filed on Jun. 10, 2009.

(51) Int. Cl. G06F 15/173

(52) U.S. Cl. 709/224

(57) ABSTRACT

The present invention is directed to a network communications system including a data communication path; a user communication device; a tapping device; and a rendering device. The user communications device (for example, a personal computer, a Blackberry type device) is structured, connected and/or programmed to receive web pages from the Internet over a data communication path. The tapping device is structured, located and/or connected to receive the communications and to send the network communication pages a rendering device. The tapping device and the rendering device are both separate from the user communications device. The rendering device converts the visual communications into corresponding bit maps. Preferably, the rendering device permanently stores the bit maps to a data storage device and/or displays the bit maps on a display device. In embodiments where the bit maps are permanently stored, the rendering device preferably compresses the bit maps.

### RELATED APPLICATION

The present application claims priority to U.S. provisional patent application No. 61/185,703, filed on 10 Jun. 2009; all of the foregoing patent-related document(s) are hereby incorporated by reference herein in their respective entirety(ies).

### BACKGROUND OF THE INVENTION

1. Field of the Invention

The present invention relates to network communication systems with monitoring, and more particularly to monitoring of visual images receiver by a network user through the World wide Web (WWW).

2. Description of the Related Art

FIG. 1 shows a portion 100 of XHTL code for a web page. FIG. 2 shows how this portion of code is rendered by a web browser (not shown) into a display 104. Some of display 104 comes directly from the code itself. For example, the word “Guest” is present in the code (see, portion 100 at line 3) and is also present in display 103. Other portions of display 103 are not directly in the code of the web page, but are rather in the form of supplemental data which is referenced in the web page, but not directly present in the web page. For example, code portion 102 (see FIG. 1) is the following command: <img src=“http://img.photobucket.com/albums/v226/farces/policevidbd-3.jpg” . . . >. As is understood in the art, this command will retrieve a compressed, bit map image in jpeg form from the Internet uniform resource locator (“URL”) location http://img.photobucket.com/albums/v226/farces/policevidbd-3.jpg. This jpeg image is shown in FIG. 2 as portion 104 of display 103.

Herein, data used to help create a web page display, but which is not directly present in the web page itself will be referred to as supplemental data. While bit map (see DEFINITIONS section), still images are a common form of supplemental data, there are also other forms of supplemental data such as video data, or computer instruction code (for example, computer programs, applets) that generate a visual display over some portion of the web page. Supplemental data will often be located at an accessible location described by a URL, but supplemental data could come from other locations, such as a storage device integrated into the computer that receives and renders the web page. For purposes of this document, supplemental data will include non-visual data, such as audio presentations. Supplemental data that is, or contributes to a visual display will be called “visual supplemental data.”

Supplemental data can be changed. As shown in FIGS. 2 and 3, jpeg image 104 was replaced, at its URL http://img.photobucket.com/albums/v226/farces/policevidbd-3.jpg, with image 106. In this example, a terrorism related message was present in the image 104, but this message was later replaced with an innocuous image 106. Which image a user will see will depend upon the point in time at which the XHTML code 100 was rendered. If it was rendered at a time when image 104 was stored at the referenced URL, then the user will see the terrorism related message 104. If it was rendered at a later time when image 106 was stored at the referenced URL, then the user will see the innocuous message 106. For example, if the active code 100 were intercepted and stored, and then rendered later, long after storage, then the intercepting party would see image 106 and not image 104.

According to a conventional system and method, network communications may be tapped by a tap and saved and/or monitored. For example, one method, known as deep packet inspection (DPI), actually looks at the stream and tries to find know or suspected problems that might be a security issue (virus etc) residing in the code. These DPI systems are also used for law enforcement. However, because DPI systems tap network communications in the form of active code (to be monitored) and/or save network communications in the form of active code (to be monitored later), there are relatively large performance demands on the monitoring system, such as transmission bandwidth demands and storage space demands. Of course, the monitored/saved active code may be rendered as visual images at the time and place that it is monitored, but until the time and place of the actual monitoring, the monitored network communication data remains in the data intensive form of active code.

U.S. Patent Application 2003/0005072 (“Olah”) discloses: “A system and method for monitoring computer usage is disclosed. A computer operator specifies discrete moments of a computer's usage at which screen captures are executed and saved to a log. The operator, such as a parent or employer, can later retrieve the screen images to provide a graphical record of the activities, such as that of their child or employees, on that computer. The system and method of the present invention gives full authority of determining what type of computer usage is inappropriate or offensive to the computer operator. Through the use of the [Olah system], an operator may determine not only whether or not a user's computer activity was inappropriate, but may also simply determine if the computer was operated in any manner. By employing the system and method of the disclosed invention, a record of a user's activity or inactivity is created that, in addition to being highly simple to evaluate, is an irrefutable account of the user's computer usage. Variations of the system and method allow the operator to direct monitoring events toward online or off-line activities.”

The following published documents may also include helpful background information: (i) U.S. patent application 2009/0253423 (“Kullberg”); (ii) U.S. patent application 2009/0252151 (“Rappe”); (iii) U.S. patent application 2009/0207751 (“Attanasio”); (iv) U.S. patent application 2007/0206741 (“Tiliks”); (v) U.S. patent application 2006/0212933 (“Scoggins”); (vi) U.S. patent application 2006/0045082 (“Fertell 1”); (vii) U.S. patent application 2005/0132046 (“de la Iglesia”); (viii) U.S. patent application 2004/0210773 (“Markosi”); (ix) U.S. patent application 2002/0162008 (“Hill”); and (x) U.S. patent application 2002/0032770 (“Fertell 2”).

Description Of the Related Art Section Disclaimer: To the extent that specific publications are discussed above in this Description of the Related Art Section, these discussions should not be taken as an admission that the discussed publications (for example, published patents) are prior art for patent law purposes. For example, some or all of the discussed publications may not be sufficiently early in time, may not reflect subject matter developed early enough in time and/or may not be sufficiently enabling so as to amount to prior art for patent law purposes. To the extent that specific publications are discussed above in this Description of the Related Art Section, they are all hereby incorporated by reference into this document in their respective entirety(ies).

### BRIEF SUMMARY OF THE INVENTION

The present invention is directed to a network communications system including a data communication path; a user communication device; a tapping device; and a rendering device. The user communications device (for example, a personal computer, a Blackberry type device) is structured, connected and/or programmed to receive network communication pages (for example, web pages) from a communication network over the data communication path (see DEFINITIONS section). The tapping device is structured, located and/or connected to receive (at least some of) the network communication pages and to send the network communication pages to a rendering device. The tapping device is separate from the user communication device and receives the network communication pages from a juncture along the data communication path the is intermediately between the source(s) of the network communication pages and the user communication device. The rendering device is separate from the user communication device. The rendering device renders the network communication pages into corresponding bit maps (see DEFINITIONS section). Preferably, the bit maps are permanently stored (see DEFINITIONS) section and/or immediately displayed on a display device.

Preferably, the rendering device compresses the data corresponding to the rendered images. Preferably, the rendering device sends the rendered images to: (i) a storage device for storage; and/or (ii) a visual display that is remote from the user communication device. Preferably, the network communication is the Internet, and the visual communications are in form and/or format(s) (now known or to be developed in the future) that are suitable for a web browser.

Various embodiments of the present invention may exhibit one or more of the following objects, features and/or advantages:

(i) improved monitoring of network communications;

(ii) more accurate, comprehensive and/or meaningful monitoring of network communications;

(iii) bandwidth efficient monitoring of network communications; and/or

(iv) storage space efficient archiving of monitored network communications.

According to one aspect of the present invention, a monitoring sub-system is used in a network communications system that includes: a source of at least one network communication page, a data communication path and a user communication device. The monitoring sub-system includes: a tapping module which is separate from the user communication device; and a rendering module which is separate from the user communication device. The tapping module is structured, programmed and/or connectable to intercept a network communication page being communicated over the data communication path from the at least one source of network communication page to the user communication device. The tapping module is further structured, programmed and/or connectable send the intercepted network communication page both: (i) back along the data communication path towards the user communication device; and (ii) to the rendering module. The rendering module comprises a render page sub-module which is structured, programmed and/or connectable to render the network communication page into a bit map.

### BRIEF DESCRIPTION OF THE DRAWINGS

The present invention will be more fully understood and appreciated by reading the following Detailed Description in conjunction with the accompanying drawings, in which:

FIG. 1 (prior art) is a portion of XHTML code for a web page;

FIG. 2 (prior art) is a display, rendered at a first point in time, corresponding to the code of FIG. 1;

FIG. 3 (prior art) is a display, rendered at a second point in time, corresponding to the code of FIG. 1;

FIG. 4 is a schematic diagram of a first embodiment of a network communication system according to the present invention;

FIG. 5 is a flow chart showing a method according to the present invention; and

FIG. 6 is a schematic diagram of a component of the first embodiment network communication system.

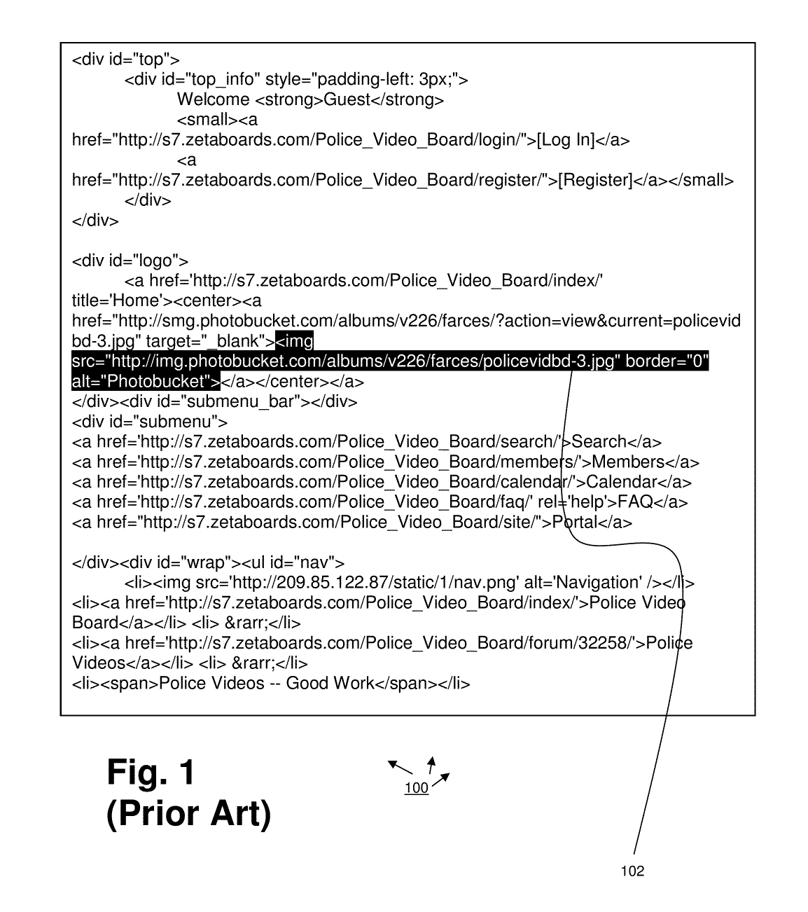

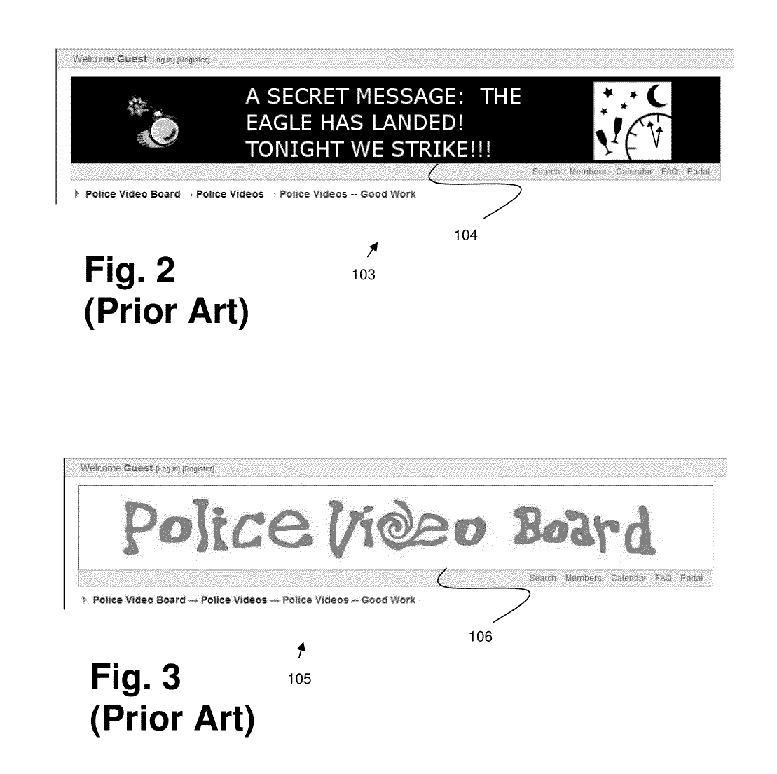

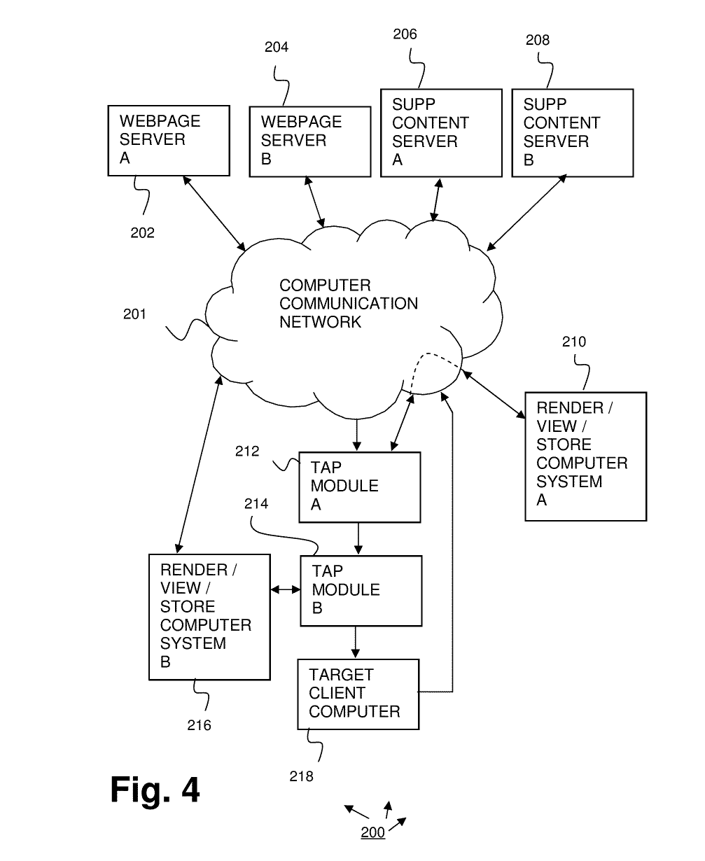

### DETAILED DESCRIPTION OF THE INVENTION

Before moving to a description of the embodiment(s) of the invention shown in the figures, some preliminary remarks will now be made. Some embodiments of the present invention (see DEFINITIONS section) are directed to a method of efficient transmission for a worldwide web (“WWW”) session monitoring and policy enforcement.

Some embodiments of the present invention are directed to a method to reduce the amount of data retransmission necessary to view (either real time or post) the actual subject users www access through a web browser that is retrieving web pages via the internet or an intranet while maintaining a true representation of the subject user's visual experience. In one embodiment, the subject user's www activity is monitored live for surveillance during a real time investigation by a remote agency or authority. some embodiments of the present invention are directed to a method including three sub-methods as follows:

(i) a “tap” on the www user's transmission line feeds a local (meaning within reasonable proximity for the transmission to be tapped) system which renders a complete graphic (void of the overhead associated with active code) of the user's visual experience allowing for lossee or lossless compression of the graphic rendering;

(iii) the transmission efficient rendering of the user's page is transmitted for remote (meaning not the same user station) monitoring and/or database inclusion; and

(iii) the graphic is either viewed and or reference stamped and archived.

Depending on the predetermined authority needs and policy enforcement one or more of the sub-methods may be employed in an active (real or near real time) or passive (the generation of an evidentiary or forensics database for later recreation of the user's www experience).

One problem solved by some embodiments of the present invention is the problem wherein the connection upload is much slower that the download and an agency doing surveillance is trying to do it covertly. It of course is useful in reducing the amount of data stored as well. Currently all the information is stored which includes each packet and this can potentially reduce the storage space required by 90% by utilizing current compression methods.

Various embodiments of the present invention, may or may not monitor information in addition to the visual information, such as downloaded files (for example, downloaded word processing documents, downloaded audio files) or streaming audio/video files (for example, You Tube type videos, Internet radio broadcasts, Intenet phone calls). As a policy, the monitor preferably should be able to “see” all the imagery that is presented on each page as the user sees it, which is why the video monitoring of the present invention is so important. The video gets parsed into a number of images them compressed as part of the whole page. Monitoring according to the present invention does not necessarily seek to capture the documents that are downloaded but rather what the user is seeing. In some applications of the present invention, the video images are all that is needed to do the monitoring that is desired.

On the other hand, in some monitoring applications it may be helpful to additionally have non-visual aspects of the network communications, such as downloaded pdf documents or the content of Internet telephone calls. However, even in these applications, it is still helpful to have the video images exactly as the user sees them, and the present invention is still helpful with this aspect of the monitoring even when the monitoring extends beyond saving or viewing the visual images.

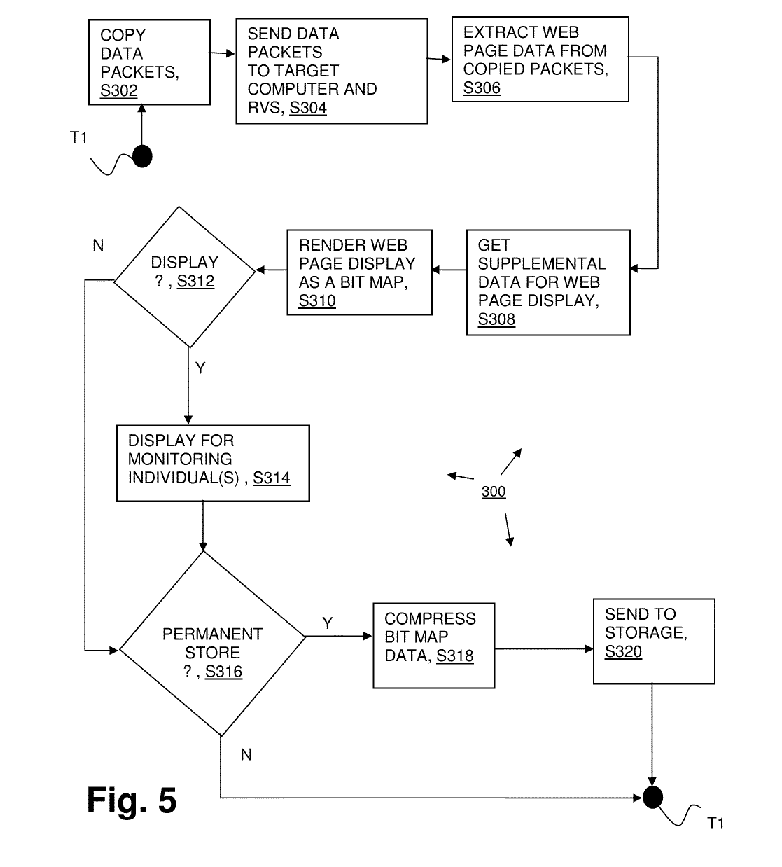

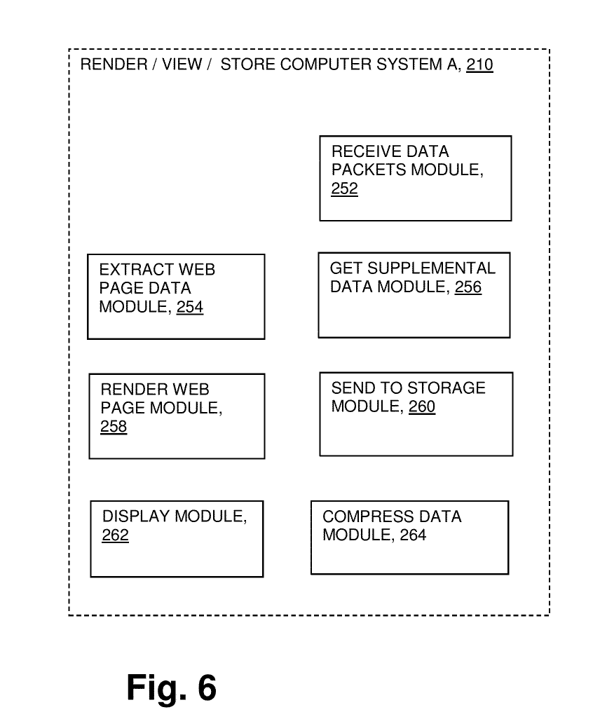

Discussion will now proceed to a description of the figures. FIG. 5 shows network communication system 200 including: computer communication network 201; webpage server computer sub-system A 202; webpage server computer sub-system B 204; supplemental content (“SC”) server computer sub-system A 206; SC server computer sub-system B 208; render/view/store (“RVS”) computer sub-system A 210; tapping module A 212; tapping module B 214; RVS computer sub-system B 216; and target client computer sub-system 218. As shown in FIG. 6, RVS 210 includes: Send data packets module 252; extract web page data module 254; get supplemental data module 256; render web page module 258; send to storage module 260; display module 262; and compress data module 264.

In operation, target client computer 218 requests that web pages be sent to it from various web page servers, such as server 202 and server 204. In response, these servers send active code for the requested web pages to the target client computer over network 201. The target client computer sub-system may be any device (now known or to be developed in the future) with the processing power, data communication ability and appropriate software to receive, render and view any network communication page (see DEFINITIONS section). the target client computer renders the web pages that it receives, including the requesting and receiving of supplemental data from supplemental data servers, such as servers 206, 208.

In this exemplary embodiment, in being communicated over the data communication path from the web page server to the target client computer, the web page active code is tapped twice, first by taping module A 212, and then by tapping module B 214. In this embodiment the tapping devices allow the tapped data to also pass on through to the target client computer. In other embodiments the tapping devices might filter and block some web pages, or may add a delay to the transmission of some or all of the web pages requested by the target client computer. In this exemplary embodiment, the difference between tapping modules A and B is that: (i) tapping module A repacketizes its intercepted data and sends it back over the network to associated RVS 210; while (ii) tapping module B sends the intercepted data to a local associated RVS 216. Tap module 214 and RVS 216 may be, or include, a single computer device that provides the memory and processing power for both tapping and the RVS functionality (to be explained below). Alternatively, these tap module B 214 and RVS 216 may be separate devices from each other, such as separate devices that communicate wirelessly.

It is important to note that tapping module A 212, tapping module B 214, RVS 210 and RVS 216 are all separate from the target client computer because monitoring, without the knowledge of the user of the target client computer, is a primary intended use of the present invention. Also, the tapping modules are preferably in the data communication path between the data sources (web page servers) and the target client computer, rather than somehow having the target client computer first receive the data and then transmit it to the tapping device.

As mentioned above, the RVS's 210, 216 receive the web pages from their respectively associated tapping modules. The operation of the tapping modules and associated RVS's will now be explained in more detail with reference to FIG. 6. Processing starts at terminal T1 and proceeds to step S302 where the tapping module copies the data packet(s) (or at least portions of the data packets) holding the data corresponding to the web page that the target client computer is being sent by the data source. Processing proceeds to step S304 where the tapping module sends the data packet along to the target client computer after it has copied the webpage data required to perform monitoring of the visual display being received by the target client computer. At step S304, the relevant packets are sent along to the associated RVS.

Processing proceeds to step S306 where the RVS extracts web page data is extracted (as may or may not be necessary) from any other intercepted data with which the web page data may be intermingled. Alternatively, this extraction processing could be performed in the tapping module.

Processing proceeds to step S308 where the web page data is evaluated to determine whether any supplemental data is required to fully render the web page, and, if so, such supplemental data is obtained (usually over the communication network, but perhaps locally or from other supplemental data locations). In some embodiments of the present invention, the supplemental data will be limited to visual supplemental data, and the monitoring will not include other aspects of the presentation at the target client computer, such as audio presentation. In other embodiments of the present invention, only limited portions of even the visual supplemental data will be obtained. For example, the monitoring may ignore supplemental data in the form of video or embedded servlet displays.

Processing proceeds to step S310 where the web page is rendered as a bit map. In other words, the active code of the web page is converted into a bit map.

Processing proceeds to step S312 which decides whether the data is to be displayed (for example, displayed visually in real time). If the bit map is not to be displayed, then processing proceeds to step S316 (to be discussed below).

If the bit map is to be displayed, then processing proceeds to step S314 where the bitmap is converted to appropriate form to be received and displayed by a display device (for example, a computer monitor device) and is sent to the display device where the rendered web page is displayed. A monitoring party may indeed be watching such a display to determine whether there is criminal evidence or any sort of security threat inherent in the display.

Processing proceeds to step S316 where it is decided whether the bit map will be permanently stored (see DEFINITIONS section). If the web page is not to be stored then processing proceeds back to terminal T1. If the web page data is to be stored, then processing proceeds to step S318 where the bit map data is compressed (by any compression algorithm now known or to be developed in the future). This compression may involve combining a multiplicity of discrete bit maps into some type of video file (which may or may not include audio).

Processing proceeds to step S320 where the compressed bit map data is stored. For example, if a suspect is under surveillance, but not of sufficient interest for a human monitor to watch a display in real time, and circumstances develop which intensify the suspicion of the suspect, then the stored bit maps may be viewed by an authorized party at the time of increased suspicion so that bad activities or intentions may be thwarted, detected and/or proven.

Now that the figures have been described, some additional comments will be made. Ideally, the tapping module would be placed near “same network leg” as the client such that the only data that passes through the tap is data that is being sent to the target of the tap. However the capability has been built in to filter for the specific client in the event that the tapping unit is “upstream” from the target client computer to the extent that data will pass through that is being sent to other user's communication devices, other than the target of the tap.

Data encryption may prevent the rendering of bit maps or portions of bit maps according to the present invention unless the key is known and the computing power is available to crack the encryption. In some preferred embodiments, the present invention is geared to handle only browser based communications that are non-encrypted.

Fertrell 2 displays a web page its self as it were displayed on the intended client system. On the other hand, rendering for purposes of the present invention is a re-displaying of the network communication page as a “bit map” (see DEFINITIONS section). In Fertrell 2, the page is a combination of image, and code to support the links and so on in the code. On the other hand, according to the present invention, the end result is a screen shot of the monitored users web experience without all of the original code/malware/control channels/etc. This reduces the monitoring system's chance of infection, corruption and so on, significantly. It also facilitates compression of permanently stored data in preferred embodiments of the present invention.

### DEFINITIONS

The following definitions are provided to facilitate claim interpretation:

Present invention: means at least some embodiments of the present invention; references to various feature(s) of the “present invention” throughout this document do not mean that all claimed embodiments or methods include the referenced feature(s).

First, second, third, etc. (“ordinals”): Unless otherwise noted, ordinals only serve to distinguish or identify (e.g., various members of a group); the mere use of ordinals implies neither a consecutive numerical limit nor a serial limitation.

Electrically Connected: means either directly electrically connected, or indirectly electrically connected, such that intervening elements are present; in an indirect electrical connection, the intervening elements may include inductors and/or transformers.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Data communication path: path for any type of data communication (see DEFINITION); a single path may be defined virtually in that it may include and subsume a multiplicity of physical paths; for example, the packets of a single Internet communication may pass through different wires when travelling from source to recipient.

permanently stored: stored more permanently than storage performed transiently for ongoing computer processing; for example, storing to a hard disk is one type of permanent storage (notwithstanding that the data may later be removed, erased or destroyed).

bit map: digital data set corresponding to a digital display that excludes active code (see DEFINITIONS section); for example, Fertrell 2 does not disclose the use of a bit map (as that term is used herein) because the monitored web pages include active code (and this can be a disadvantage both because it takes up storage space, but also because the active code may be harmful to the machine doing the monitoring).

network communication page: any data set that can be communicated over a network to specify, arrange and organize the content of (at least) a visual display; network communication pages include, but are not limited to: web pages; data in packetized form; a data set that references supplemental data to complete the visual display; and/or data written according to a markup language (for example, HTML).

Receive/provide/send/input/output: unless otherwise explicitly specified, these words should not be taken to imply: (i) any particular degree of directness with respect to the relationship between their objects and subjects; and/or (ii) absence of intermediate components, actions and/or things interposed between their objects and subjects.

Visual communications: any set of network communications in active code form that can be (at least partially) rendered into visual images (still or moving images) suitable for display on a display; visual communications may or may not include active code corresponding to things other than visual images, such as audio or software instructions.

Active code: data set that includes code for a visual display and also links and/or computer readable instructions in addition to the data corresponding to a visual display; for example, many, if not most web pages are active code because they include data corresponding to links and may also include executable instructions such as malware, or software that is not harmful.

To the extent that the definitions provided above are consistent with ordinary, plain, and accustomed meanings (as generally shown by documents such as dictionaries and/or technical lexicons), the above definitions shall be considered supplemental in nature. To the extent that the definitions provided above are inconsistent with ordinary, plain, and accustomed meanings (as generally shown by documents such as dictionaries and/or technical lexicons), the above definitions shall control. If the definitions provided above are broader than the ordinary, plain, and accustomed meanings in some aspect, then the above definitions shall be considered to broaden the claim accordingly.

To the extent that a patentee may act as its own lexicographer under applicable law, it is hereby further directed that all words appearing in the claims section, except for the above-defined words, shall take on their ordinary, plain, and accustomed meanings (as generally shown by documents such as dictionaries and/or technical lexicons), and shall not be considered to be specially defined in this specification. In the situation where a word or term used in the claims has more than one alternative ordinary, plain and accustomed meaning, the broadest definition that is consistent with technological feasibility and not directly inconsistent with the specification shall control.

Unless otherwise explicitly provided in the claim language, steps in method steps or process claims need only be performed in the same time order as the order the steps are recited in the claim only to the extent that impossibility or extreme feasibility problems dictate that the recited step order (or portion of the recited step order) be used. This broad interpretation with respect to step order is to be used regardless of whether the alternative time ordering(s) of the claimed steps is particularly mentioned or discussed in this document.

What is claimed is:

1. A monitoring sub-system for use in a network communications system comprising at least one source of at least one network communication page, a data communication path and a user communication device, the monitoring sub-system comprising:
a tapping module which is separate from the user communication device; and
a rendering module which is separate from the user communication device;
wherein:
the tapping module is structured, programmed and/or connectable to intercept a network communication page being communicated over the data communication path from the at least one source of network communication page to the user communication device;
the tapping module is further structured, programmed and/or connectable send the intercepted network communication page both: (i) back along the data communication path towards the user communication device; and (ii) to the rendering module; and
the rendering module comprises a render page sub-module which is structured, programmed and/or connectable to render the network communication page into a bit map.

2. The sub-system of claim 1 wherein the rendering module is further comprises a storage sub-module structured, programmed and/or connectable to send the bit map to permanent storage.

3. The sub-system of claim 1 wherein the rendering module is further comprises:
a compress data sub-module structured, programmed and/or connectable to compress the bit map to form a compressed bit map; and
a storage sub-module structured, programmed and/or connectable to send the compressed bit map to permanent storage.

4. The sub-system of claim 1 wherein the rendering module is further comprises a display sub-module structured, programmed and/or connectable to send the bit map to a display device for display.

5. The sub-system of claim 3 wherein the render page sub-module is further structured, programmed and/or connectable to disregard any supplemental data referenced in the network communication page when rendering the network communication page into a bit map.

6. The sub-system of claim 1 wherein:
the rendering module is further comprises a supplemental data sub-module structured, programmed and/or connectable to retrieve any supplemental data referenced in the network communication page; and
the render page sub-module which is further structured, programmed and/or connectable to use the supplemental data retrieved by the supplemental data sub-module when rendering the network communication page into a bit map.

7. The sub-system of claim 1 wherein:
the network communication pages are web pages; and
the web pages are communicated along the data communication path in the form of data packets including active code in a markup language.

8. A network communications system comprising:
at least one source of at least one network communication page;
a data communication path;
a user communication device;
a tapping module which is separate from the user communication device; and
a rendering module which is separate from the user communication device;
wherein:
the at least one source is structured, programmed and/or connected to send the network communication page to the user communication device over the data communication path;
the tapping module is structured, programmed and/or connectable to intercept network communication page being communicated over the data communication path from the at least one source of network communication pages to the user communication device;
the tapping module is further structured, programmed and/or connectable send the intercepted network communication pages both: (i) back along the data communication path towards the user communication device; and (ii) to the rendering module; and
the rendering module comprises a render page sub-module which is structured, programmed and/or connectable to render the network communication page into a bit map.

9. The system of claim 8 further comprising a storage device wherein the rendering module is further comprises a storage sub-module structured, programmed and/or connectable to permanently store the bit map to in the storage device.

10. The system of claim 8 wherein the rendering module is further comprises:
a compress data sub-module structured, programmed and/or connectable to compress the bit map to form a compressed bit map; and
a storage sub-module structured, programmed and/or connectable to send the compressed bit map to permanent storage.

11. The system of claim 8 wherein the data communication path runs, at least in part, through the internet.

12. The system of claim 8 wherein the network communication page is a web page.

13. A method of monitoring a network communication, the method comprising the following steps (not necessarily in the following order):
intercepting a network communication page being communicated over the data communication path from a source of network communication page to a user communication device;
sending the intercepted network communication page back along the data communication path towards the user communication device; and
the rendering module, in a device separate from the user communication device, the network communication page into a bit map.

14. The method of claim 13 further comprising the step of permanently storing the bit storing
